(19) United States
(12) Patent Application Publication
(10) Pub. No.: US 2004/0196888 A1
(43) Pub. Date: Oct. 7, 2004

(54) IR thermometer for automotive applications

(75) Inventors: Jim Musbach, Capitola, CA (US); Phan T. Nguyen, Pacifica, CA (US)

Correspondence Address: LAW OFFICE OF CHARLES E. KRUEGER, P.O. BOX 5607, WALNUT CREEK, CA, 94596-1607, US

(73) Assignee: FLUKE CORPORATION

(21) Appl. No.: 10/699,220

(22) Filed: Oct. 31, 2003

Related U.S. Application Data
(60) Provisional application No. 60/423,672, filed on Oct. 31, 2002.

(51) Int. Cl. G01K 1/08

(52) U.S. Cl. 374/120; 374/141

(57) ABSTRACT

An IR thermometer instrument adapted for automotive applications including a dual-laser sighting system, workpiece illumination system, and magnetic seat for mounting the instrument on ant automobile being serviced.

### BACKGROUND OF THE INVENTION

This application claims priority from a provisional patent application entitled IR THERMOMETER FOR AUTOMOTIVE APPLICATIONS, A/No. 60/423,672, filed Oct. 31, 2002, which is hereby incorporated by reference for all purposes.

Many automobile repair operations, such as engine misfires and emissions problems, catalytic converters, engine troubleshooting, wheel hubs/bearings, brake inspections air conditioning, cooling systems, heaters/heater cores and rear window defrosters, require measurement of temperature.

### BRIEF SUMMARY OF THE INVENTION

Automotive technicians require an infrared thermometer that can provide an easy, accurate response from a close distance. An embodiment of the present invention, designated AutoPro by the assignee of the present application, features SmartSight™, a bright dual laser sighting system that merges into a single laser point when the unit is at the optimal distance from the object being measured. With SmartSight, a technician can easily pinpoint the actual measurement area 13 mm (0.5 inches) from a close distance 200 mm (8 inches), and obtain an instantaneous result with 1% accuracy.

In one embodiment, the AutoPro IR thermometer also features a bright white LED that conveniently illuminates the work area, and a removable, powerful magnet is attached to the base of the unit for handy, safe storage.

The AutoPro IR Thermometer is uniquely suited to perform many automotive diagnostic applications such as: engine misfires and emissions problems, catalytic converter function, engine troubleshooting, wheel hubs and bearing function, brake inspections, air conditioning and cooling system diagnosis and repair, heaters/heater cores and rear window defrosters.

### BRIEF DESCRIPTION OF THE DRAWINGS

FIG. 1A is a perspective view of a preferred embodiment;

FIG. 1B is a perspective view of a preferred embodiment;

FIG. 2 is a diagram of the display in a preferred embodiment;

FIG. 3 is a schematic view of the crossed laser sighting beams; and

FIG. 4 is a diagram depicting the relationship of distance and spot size.

### DETAILED DESCRIPTION OF THE INVENTION

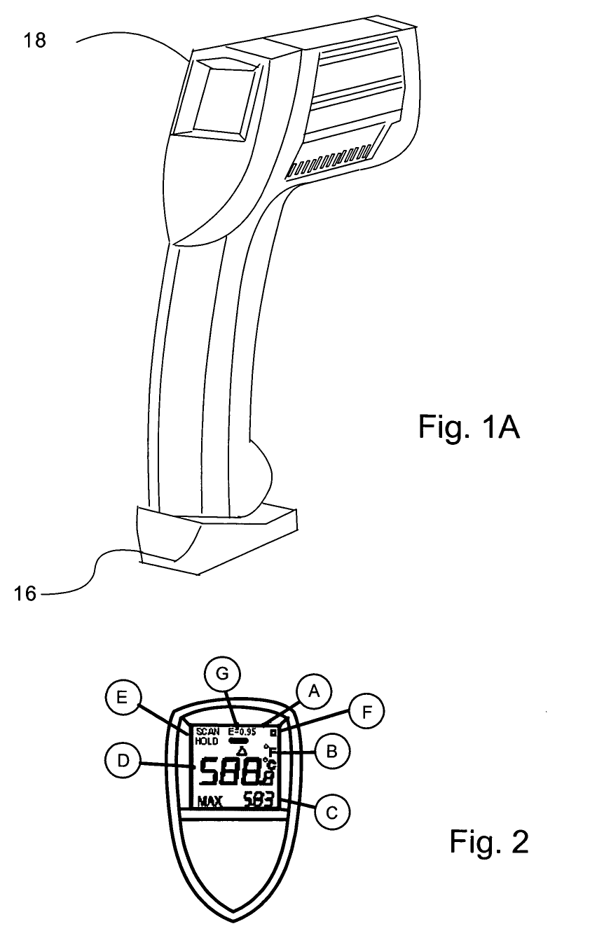

Features of the present embodiment, depicted in FIGS. 1A and 1B include: Dual laser sighting system 12 that demonstrates the focal point by merging the two laser points. At the focal point, there is a useful (for automobile repair) measurement spot size of 0.5 inch (13 mm) at 8 inches (200 mm). The D:S information is described below so that customers will have an idea of the measurement spot when not at focal point.

Illumination of the target area for visual (working) reasons, not for sighting. This will help the technician by eliminating the need to use a separate flashlight in many circumstances. This may free a hand to use another tool. Illumination in this embodiment is via an LED 14, alternatively an a flashlight bulb can be utilized.

Removable, powerful magnet 16 attached to base of unit for attaching the thermometer to the auto being serviced, as a convenience feature.

Bright color housing highlights (i.e. display cover and nose) to easily find the thermometer against a background of automotive engine: colors (black, gray, etc).

Flexible “boot” rubber-like, removable housing covering for appearance and function of extra ruggedness. Must be made of material that can cost-effectively have different colors.

Accordingly a list of Features includes: Dual laser sighting 12; LED Flashlight 14; Wide temperature range; MAX temperature display; Back-lit graphic display 18; Tripod mount; Removable magnetic Base 16; Durable, ergonomic construction; Options/Accessories; Nylon Holster; N.I.S.T./DKD Certification, and a detailed users manual with technical information specific to the effective use of AutoPro in automotive repair applications. The removable magnetic base is designed specifically to enable the technician to temporarily adhere the unit under-car, or under-hood—allowing quick access and free use of hands during repairs. The LED flashlight enables the technician to illuminate the immediate work area, allowing precision measurements in low light and crowded working spaces.

The display is depicted in FIG. 2. The display includes: A) Low battery indicator (comes on when battery is low); B) ° C./° F. symbol; C) Maximum temperature value continuously updated while the unit is on); D) Temperature display; E) Scan/Hold indicator Display; F) Laser/Backlight/LED on indicator; G) Emissivity indicator.

In the scan mode, the backlit LCD displays both the current temperature (D) and maximum temperature (C) in Celsius or Fahrenheit (B). The unit will hold the last reading for 7 seconds after the trigger is released; the word HOLD appears (E). The presence of the battery icon (A) indicates a low battery. The presence of a light bulb (F) will indicate backlight and LED flashlight are on. When trigger is pulled triangular icon will be present indicating laser is on.

The manner in which the present embodiment works will now be described. Infrared thermometers measure the surface temperature of an object. The unit's optics sense emitted, reflected, and transmitted energy which are collected and focused onto a detector. The unit's electronics translate the information into a temperature reading displayed on the unit. The lasers are used for aiming purposes only.

How to Operate the Embodiment:

Measurement: Quick Start:

To measure an object, point the unit at an object, and pull the trigger. Move the unit in and out to merge the 2 laser dots on the target into one dot. When the two dots are converged the measurement area is a 13 mm (1/2″) diameter spot.

Switching ° C. and ° F.; Changing the Battery; Laser/Backlight/LED On/Off

Before opening the unit's handle to access the battery and controls, use a Phillips head screwdriver to remove the base magnet. To open the unit's handle, push the button near the trigger on the underside of the unit, and pull the handle down and forward.

To select ° C. or ° F., slide the top switch (A) up for Celsius and down for Fahrenheit. To activate the lasers, backlight and LED flashlight, slide the lower switch (B) down. Dual lasers and LED flashlight will turn on when the trigger is pulled. The lasers and LED flashlight will turn off when the trigger is released. The backlight will remain on for 7 seconds after the trigger is released.

To change the 9V battery, attach the battery to the battery snaps with the positive side toward the rear of the battery compartment.

How to Accurately Measure Temperature:

Laser Sighting

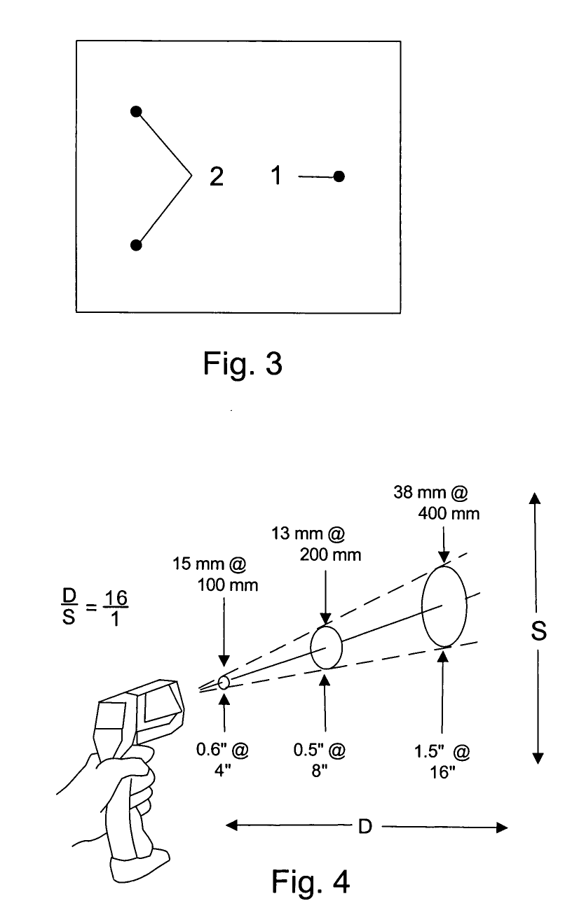

Laser sighting consists of 2 lasers as depicted in FIG. 3. These lasers are aimed at different angles. The point at which the two laser points intersect (thermometer focused) is 8 inches (200 mm). This is also the optimum measuring distance.

To sight object being measured, press trigger to turn on laser sight. Only one laser point should be seen when at optimum measuring distance (1). If two laser points are visible (2), adjust distance of unit from object being measured. If it is not possible to adjust the distance, see Distance & Spot Size information.

Distance & Spot Size

The relationship between distance and spot size as depicted in FIG. 4 is 16:1 at the focus point (200 mm: 13 mm or 8 inches: 0.5 inch). As the distance (D) from the object decreases or increases, the spot size (S) of the are measured by the unit becomes larger. The spot sizes indicate 90%-encircled energy.

Emissivity

Emissivity is a term used to describe the energy emitting characteristics of materials. Most organic materials and painted or oxidized surfaces have an emissivity of 0.95 (pre-set in the unit). Inaccurate readings can result from measuring shiny or polished metal surfaces. To compensate, cover, the surface to be measured with masking tape or flat black-paint. Allow time for the tape or paint to reach the same temperature as the material underneath it. Measure the temperature of the tape or painted surface.

Locating a Hot or Cold Spot

To find a hot or cold spot, aim the thermometer outside the area of interest. Then scan across the area with an up and down motion until you locate the hot or cold spot.

The invention has now been described with reference to the preferred embodiments. Alternatives and substitutions will now be apparent to persons of skill in the art. Accordingly, it is not intended to limit the invention except as provided by the appended claims.

What is claimed is:

1. An IR thermometer adapted for use in automobile diagnostic and repair operation comprising:
IR sensing and processing means including IR optics, having a focal length, for directing IR emanated from an energy zone onto an IR sensor and determining the temperature of the energy zone;
a dual laser cross beamed sighting system including two lasers oriented to have their beams cross at the focal point of the IR optics;
a light for illuminating an area surrounding the energy zone; and
a magnetic base for creating an attachment to an auto being served.

2. An IR thermometer adapted for use in automobile diagnostic and repair operation comprising:
IR sensing and processing means including IR optics, having a focal length, for directing IR emanated from an energy zone onto an IR sensor and determining the temperature of the energy zone.

3. An IR thermometer adapted for use in automobile diagnostic and repair operation comprising:
a light for illuminating, an area surrounding the energy zone.

4. An IR thermometer adapted for use in automobile diagnostic and repair operation comprising:
a magnetic base for creating an attachment to an auto being served.
